(19) United States
(12) Patent Application Publication
(10) Pub. No.: US 2008/0318587 A1
(43) Pub. Date: Dec. 25, 2008

(54) Cellular Communication System, a Base Station and a Method of Resource Allocation

(75) Inventor: Stephen J. Barrett, Curridge (GB)

Correspondence Address: MOTOROLA, INC., 1303 EAST ALGONQUIN ROAD, IL01/3RD, SCHAUMBURG, IL, 60196, US

(73) Assignee: MOTOROLA, INC., Schaumburg, IL (US)

(21) Appl. No.: 11/574,999

(22) PCT Filed: Nov. 18, 2005
(86) PCT No.: PCT/US05/42252

§ 371 Date: Mar. 9, 2007

(30) Foreign Application Priority Data
Dec. 6, 2004 (GB) 0426683.9

(51) Int. Cl. H04Q 7/20

(52) U.S. Cl. 455/452.1

(57) ABSTRACT

A cellular communication system (100) comprises a network controller (113) having a first resource allocator (117) for allocating codes to a first set of calls in a cell. The network controller (113) is coupled to a base station (109) which comprises a second resource allocator (119) for allocating codes to a second set of calls in the cell. The first resource allocator (117) and the second resource allocator (119) share a code tree associated with the cell. The base station (109) comprises a code tree processor (209) that determines which codes are allocated by the first resource allocator (117) in response to call event signalling received from the network controller (113). The call event signalling may be related to a call setup, a call termination, a call handover and/or a call admission characteristic. The second resource allocator (119) allocates codes in response to the codes allocated by the first resource allocator (117) and in particular may allocate only codes not used by the first resource allocator (117).

### FIELD OF THE INVENTION

The invention relates to a cellular communication system, a base station and a method of resource allocation and in particular, but not exclusively to code allocation in a 3^{rd} Generation Cellular communication system.

### BACKGROUND OF THE INVENTION

In a cellular communication system, a geographical region is divided into a number of cells served by base stations. The base stations are interconnected by a fixed network which can communicate data between the base stations. A mobile station is served via a radio communication link from the base station of the cell within which the mobile station is situated.

A typical cellular communication system extends coverage over an entire country and comprises hundreds or even thousands of cells supporting thousands or even millions of mobile stations. Communication from a mobile station to a base station is known as the uplink, and communication from a base station to a mobile station is known as the downlink.

The fixed network interconnecting the base stations is operable to route data between any two base stations, thereby enabling a mobile station in a cell to communicate with a mobile station in any other cell. In addition, the fixed network comprises gateway functions for interconnecting to external networks such as the Internet or the Public Switched Telephone Network (PSTN), thereby allowing mobile stations to communicate with landline telephones and other communication terminals connected by a landline. Furthermore, the fixed network comprises much of the functionality required for managing a conventional cellular communication network including functionality for routing data, admission control, resource allocation, subscriber billing, mobile station authentication etc.

The most ubiquitous cellular communication system is the 2nd generation communication system known as the Global System for Mobile communication (GSM). GSM uses a technology known as Time Division Multiple Access (TDMA) wherein user separation is achieved by dividing frequency carriers into 8 discrete time slots, which individually can be allocated to a user. Further description of the GSM TDMA communication system can be found in ‘The GSM System for Mobile Communications’ by Michel Mouly and Marie Bernadette Pautet, Bay Foreign Language Books, 1992, ISBN 2950719007.

Currently, 3rd generation systems are being rolled out to further enhance the communication services provided to mobile users. The most widely adopted 3rd generation communication systems are based on Code Division Multiple Access (CDMA) technology. Both Frequency Division Duplex (FDD) and Time Division Duplex (TDD) techniques employ this CDMA technology. In CDMA systems, user separation is obtained by allocating different spreading and scrambling codes to different users on the same carrier frequency and in the same time intervals. In TDD, additional user separation is achieved by assigning different time slots to different users in a similar way to TDMA. However, in contrast to TDMA, TDD provides for the same carrier frequency to be used for both uplink and downlink transmissions. An example of a communication system using this principle is the Universal Mobile Telecommunication System (UMTS). Further description of CDMA and specifically of the Wideband CDMA (WCDMA) mode of UMTS can be found in ‘WCDMA for UMTS’, Harri Holma (editor), Antti Toskala (Editor), Wiley & Sons, 2001, ISBN 0471486876.

In a 3rd generation cellular communication system, the communication network comprises a core network and a Radio Access Network (RAN). The core network is operable to route data from one part of the RAN to another, as well as interfacing with other communication systems. In addition, it performs many of the operation and management functions of a cellular communication system, such as billing. The RAN is operable to support wireless user equipment over a radio link of the air interface. The RAN comprises the base stations, which in UMTS are known as Node Bs, as well as Radio Network Controllers (RNC) which control the base stations and the communication over the air interface.

The RNC performs many of the control functions related to the air interface including radio resource management and routing of data to and from appropriate base stations. It further provides the interface between the RAN and the core network. An RNC and associated base stations are collectively known as a Radio Network Subsystem (RNS).

3rd generation cellular communication systems have been specified to provide a large number of different services including efficient packet data services. For example, downlink packet data services are supported within the 3^{rd} Generation Partnership Project 3GPP release 5 specifications in the form of the High Speed Downlink Packet Access (HSDPA) service.

In accordance with the 3GPP specifications, the HSDPA service may be used in both Frequency Division Duplex (FDD) mode and Time Division Duplex (TDD) mode.

HSDPA seeks to provide packet access services with a relatively low resource usage and with low latency.

Specifically, HSDPA uses a number of techniques in order to reduce the resource required to communicate data and to increase the capacity of the communication system. These techniques include Adaptive Coding and Modulation (AMC), retransmission with soft combining and fast scheduling performed at the base station.

In HSDPA, transmission code resources are shared amongst users according to their traffic needs. The base station (also known as the Node-B for UMTS) is responsible for allocating and distributing the HSDPA resources amongst the individual calls. In a UMTS system that supports HSDPA, some of the code allocation is performed by the RNC whereas other code allocation, or more specifically, scheduling is performed by the base station. Specifically, the RNC allocates a set of resources to each base station, which the base station can use exclusively for high speed packet services. The RNC furthermore controls the flow of data to and from the base stations. However, the base station is responsible for scheduling HS-DSCH transmissions to the mobile stations that are attached to it, for operating a retransmission scheme on the HS-DSCH channels, for controlling the coding and modulation for HS-DSCH transmissions to the mobile stations and for transmitting data packets to the mobile stations.

In order to reduce the resource usage for HSDPA channels, scheduling is thus performed at the base station. This allows scheduling to be sufficiently fast to dynamically follow radio condition variations. For example, when more than one mobile station requires resource from the shared HSDPA channel, the base station may schedule data to the mobile stations experiencing favourable radio conditions in preference to the mobile stations experiencing less favourable conditions. Furthermore, the resources allocated and the coding and modulation applied to transmissions to mobile stations may be highly tailored to the current radio conditions experienced by the individual mobile station. Thus, the fast scheduling performed at the base station, based on the fast fluctuations of the different radio propagation conditions, allows link adaptation and an efficient resource usage.

The resource allocation of an HSDPA communication system is thus shared between the RNC and the base station in order to allow fast scheduling taking the radio propagation conditions into account. In particular, the CDMA codes available for a cell may be used by an RNC for allocating conventional channels (non-HSDPA channels) or by the base station for allocating HSDPA channels. Typically, the codes are logically organised in a code tree wherein codes corresponding to higher spreading factors are branches of codes corresponding to lower spreading factors. An allocation of a code in a code tree invalidates all branches of the code tree for use by any other channel. In order to avoid conflicts between the RNC scheduling function and the base station scheduling function, the available code tree must be shared between the RNC and the base station.

This sharing is conventionally performed by a fixed code partitioning wherein a section of the code tree is permanently (or semi-permanently) allocated to the RNC and a different section of the code tree is permanently (or semi-permanently) allocated to the base station. Typically, this partitioning is performed at the cell setup stage. However, such an approach results in an inefficient usage of code resource and may in particular result in one partition being fully utilised whilst the other partition has available resource. Thus, unnecessary call dropping or blocking of one type of call will occur despite the cell having available resource.

It has been proposed that the base station and the RNC may establish a signalling scheme for the purpose of changing the code partitioning. In particular it has been proposed to use a PHYSICAL SHARED CHANNEL RECONFIGURATION REQUEST message as defined in 3GPP Technical Specification TS25.433 (NBAP) to establish a communication allowing for the code partitioning to be changed. However, such an approach would substantially increase the signalling between the base station and the RNC and is thus complex and results in increased usage of backhaul resource. Furthermore, the approach is relatively slow and would result in a slow update of the code partitioning. Specifically, such a procedure will take a few seconds to complete and accordingly the update rate would at best be once every few seconds. This delay will result in an inefficient code utilisation, particularly when overall code utilisation in both partitions is high (which is exactly when an efficient partitioning is critical). Such inefficiency can arise for example because calls may be instigated and terminated at a time scale in the order of a second. Accordingly, by the time the signalling is completed, the need for the code partition re-assignment may no longer exist. In addition it is not always optimal for a new call set-up request to be queued while waiting for the signalling associated with the code re-assignment to complete.

Hence, an improved resource allocation would be advantageous and in particular a resource allocation approach of a cellular communication system allowing increased flexibility, increased resource allocation efficiency, increased speed, reduced drop/blocking rates and/or increased capacity and/or performance of the cellular communication system would be advantageous.

### SUMMARY OF THE INVENTION

Accordingly, the Invention seeks to preferably mitigate, alleviate or eliminate one or more of the above mentioned disadvantages singly or in any combination.

According to a first aspect of the invention there is provided a cellular communication system comprising: a network controller comprising a first resource allocator for allocating codes to a first set of calls in a cell from a code tree associated with a cell; a base station coupled to the network controller and comprising a second resource allocator for allocating codes to a second set of calls in the cell from the code tree associated with the cell; wherein the base station comprises means for determining codes allocated by the first resource allocator in response to call event signalling received from the network controller; and the second resource allocator is operable to allocate codes in response to the codes allocated by the first resource allocator.

The invention may provide improved performance of a cellular communication system and may in particular provide a more efficient and/or flexible resource allocation thereby potentially increasing the capacity of the cellular communication system. In some embodiments, call drop and/or blocking rates may be reduced leading to improved quality of service for the end user. In particular, a fast resource allocation and/or resource partitioning of the code tree between the network controller and the base station may be achieved in many embodiments. Also, in many embodiments a reduction in the communication requirement between the network controller and the base station may be reduced.

In particular, in some embodiments, a fast and dynamic resource allocation of a shared code tree resource for a cell between a network controller and a base station may be achieved using call event signalling without requiring any dedicated code tree allocation messages to be exchanged between the base station and the network controller.

The invention may in some embodiments provide for a low complexity implementation and reduce the number of messages exchanged between the network controller and the base station. Furthermore, call event signalling may in some embodiments comprise or consist of standard messages communicated for other purposes and/or the dynamic code tree division may be implemented without introducing new messages or requiring modifications to existing standards.

The network controller may for example be a Radio Network Controller (RNC).

According to an optional feature of the invention, the means for determining codes allocated by the first resource allocator is operable to determine a subset of the code tree used by the first resource allocator, and the second resource allocator is operable to allocate only codes not belonging to the subset. This may facilitate implementation and provide for a low complexity yet efficient resource allocation. For example, the base station may simply determine that it may use all codes not currently used by the network controller.

According to an optional feature of the invention, the call event signalling comprises signalling for a plurality of call events; and the means for determining codes allocated by the first resource allocator is operable to designate a code of the code tree as unavailable for the second resource allocator in response to call event signalling for a single call event. This may facilitate implementation and provide for an efficient system. Specifically, the base station may exploit information in call event signalling of individual calls to build up information of which codes of the code tree are currently available. For example, if a message is received that indicates that a specific network controller resource managed call uses a specific code, this code is marked as unavailable in the code tree used by the second resource allocator. This may e.g. allow dynamic resource division of a code tree based on existing call event signalling for individual calls.

According to an optional feature of the invention, the call event signalling comprises an indication of a code allocation by the first resource allocator associated with the single call event. This provides for an efficient system. For example, the indication may specifically indicate that a specific code previously used by a call has been released in response to the call event.

According to an optional feature of the invention, the code allocation is an allocation of a code to a call associated with the call event. This provides for an efficient system. For example, the indication may specifically indicate that a specific code has been allocated to the call in response to the call event.

According to an optional feature of the invention, the call event signalling comprises call setup signalling. This may allow a low complexity but efficient dynamic resource allocation system. In particular, the feature may allow the base station to determine that a code of the code tree is no longer available as a call setup has been performed using the code. The call setup messages are typically communicated to the base station in order to instigate the call and this message may in some embodiments of the invention also be used to determine which codes may be scheduled by the base station.

According to an optional feature of the invention, the call event signalling comprises handover signalling. This may allow a low complexity but efficient dynamic resource allocation system. In particular, the feature may allow the base station to determine that a code of the code tree is no longer available as a handover has been performed using the code or that a code is now available as it has been released due to a handover. The handover messages are typically communicated to the base station in order to carry out the handover and this message may in some embodiments also be used to determine which codes are available for scheduling by the base station.

According to an optional feature of the invention, the call event signalling comprises call termination signalling. This may allow a low complexity but efficient dynamic resource allocation system. In particular, the feature may allow the base station to determine that a code of the code tree is now available as it has been released due to a call termination (which may be a call drop). The call termination messages are typically communicated to the base station for other purposes and this message may in some embodiments of the invention also be used to determine which codes may be scheduled by the base station.

In some embodiments, the call event signalling comprises call reconfiguring signalling. This may allow a low complexity but efficient dynamic resource allocation system. The call reconfiguring may for example be a change of data rate resulting in a changed spreading factor and accordingly in a previously used code being replaced by a new code of the code tree.

According to an optional feature of the invention, the cellular communication system further comprises means for designating a first subset of the code tree as allocated to the first resource allocator and a second subset of the code tree as allocated to the second resource allocator. The cellular communication system may in particular implement a partitioning of the code tree between the network controller and the base station. The first resource allocator is thus operable to allocate codes of the first subset as a default and the second resource allocator is operable to allocate codes of the second subset as a default. This may facilitate operation and may provide a default resource sharing of the code tree.

In some embodiments, the first resource allocator 117 may only allocate codes of the first section unless all suitable codes of the first section are already used. Similarly, in some embodiments, the second resource allocator 119 may only allocate codes of the second section unless all suitable codes of the second section are already used.

According to an optional feature of the invention, the first resource allocator is operable to temporarily allocate codes of the second subset to the first set of calls. For example, the first resource allocator may allocate a code of the second subset to a call if all codes of the first subset are used.

According to an optional feature of the invention, the first resource allocator is operable to allocate codes of the second subset in response to a buffer loading associated with the second set of calls. This may provide for an efficient, fast and/or low complexity code tree sharing. The buffer loading may be a good indication of the proportion of codes of the second subset which are used by the second resource allocator and therefore provides a good indication of the impact of the first resource allocator temporarily using a code of the second section allocated to the second resource allocator.

According to an optional feature of the invention, the first resource allocator is operable to allocate codes of the second subset in response to a delay associated with the second set of calls. This may provide for an efficient, fast and/or low complexity code tree sharing. The delay may be a good indication of the proportion of codes of the second subset which are used by the second resource allocator and therefore provides a good indication of the impact of the first resource allocator temporarily using a code of the second section allocated to the second resource allocator. The delay may e.g. be a buffer delay or other transmission delay of the transmission path.

According to an optional feature of the invention, the first resource allocator is operable to allocate codes of the second subset in response to a throughput associated with the second set of calls. This may provide for an efficient, fast and/or low complexity code tree sharing. The throughput may be a good indication of the proportion of codes of the second subset which are used by the second resource allocator and therefore provides a good indication of the impact of the first resource allocator temporarily using a code of the second section allocated to the second resource allocator.

According to an optional feature of the invention, the first resource allocator is operable to allocate codes of the second subset in response to a call admission characteristic associated with the second set of calls. This may provide for an efficient, fast and/or low complexity code tree sharing. The call admission characteristic may be a good indication of the proportion of codes of the second subset which are used by the second resource allocator and therefore provides a good indication of the impact of the first resource allocator temporarily using a code of the second section allocated to the second resource allocator. The call admission characteristic may for example be a call blocking rate.

According to an optional feature of the invention, the network controller comprises means for determining an increased code requirement of the second subset by the second resource allocator and the first resource allocator is operable to terminate a call of the first set of calls having a code allocated of the second subset in response to the determination of the increased code requirement. This may provide for improved performance. In particular, it may allow that unused codes of the second subset are temporarily used by the first resource allocator but are released automatically if likely to be needed by the second resource allocator at a later stage.

According to an optional feature of the invention, the cellular communication system is a 3^{rd} Generation Cellular communication system.

According to an optional feature of the invention, the second set of calls comprises HSDPA calls. The cellular communication system may specifically support HSDPA and some embodiments of the invention may allow for an efficient code tree sharing between the non-HSDPA resource allocator of the Radio Network Controller (RNC) and the HSDPA resource allocator of the base station, thereby providing an increased efficiency of the resource utilisation resulting in improved capacity.

According to a second aspect of the invention, there is provided a base station for a cellular communication system having a network controller comprising a first resource allocator for allocating codes to a first set of calls in a cell from a code tree associated with a cell; the base station comprising: a second resource allocator for allocating codes to a second set of calls in the cell from the code tree associated with the cell; means for determining codes allocated by the first resource allocator in response to call event signalling received from the network controller; and wherein the second resource allocator is operable to allocate codes in response to the codes allocated by the first resource allocator.

According to a third aspect of the invention, there is provided a method of resource allocation in a cellular communication system, the method comprising: a first resource allocator of a network controller allocating codes to a first set of calls in a cell from a code tree associated with the cell; at a base station determining codes allocated by the first resource allocator in response to call event signalling received from the network controller; and a second resource allocator of a base station allocating codes to a second set of calls in the cell from the code tree associated with the cell in response to the codes allocated by the first resource allocator.

These and other aspects, features and advantages of the invention will be apparent from and elucidated with reference to the embodiment(s) described hereinafter.

### BRIEF DESCRIPTION OF THE DRAWINGS

Embodiments of the invention will be described, by way of example only, with reference to the drawings, in which

FIG. 1 illustrates elements of a cellular communication system incorporating some embodiments of the invention;

FIG. 2 illustrates elements of a base station in accordance with embodiments of the invention.

### DETAILED DESCRIPTION OF EMBODIMENTS OF THE INVENTION

The following description focuses on embodiments of the invention applicable to a 3^{rd} generation cellular communication system and in particular to a UMTS cellular communication system supporting HSDPA (High Speed Downlink Packet Access) services. However, it will be appreciated that the invention is not limited to this application but may be applied to many other cellular communication systems.

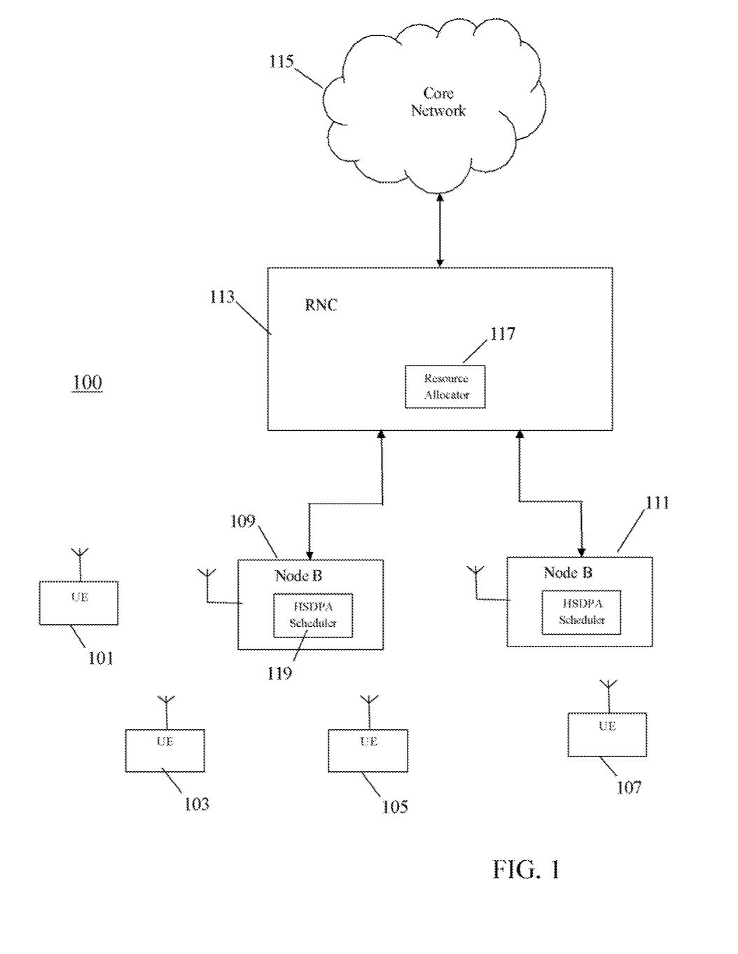

FIG. 1 illustrates elements of a cellular communication system 100 incorporating some embodiments of the invention.

In the example of FIG. 1, user equipments 101, 103, 105, 107 are supported by base stations (node Bs) 109, 111. The base stations 109, 111 are coupled to a Radio Network Controller (RNC) 113 which is coupled to a core network 115 as is typical for UMTS cellular communication systems. In the example of FIG. 1, the user equipments 101, 103 are located in a first cell supported by the first base station 109 and the user equipments 105, 107 are located in a second cell supported by the second base station 111. It will be appreciated that although each cell of the current example is supported by a separate base station, individual base stations may in other examples support more than one cell.

For clarity and brevity, FIG. 1 illustrates only aspects of the communication system required to describe exemplary embodiments of the invention. Similarly, only the functionality and features required to describe the embodiments will be described and it will be apparent to the person skilled in the art that the illustrated elements will be capable of performing other functions and provide features required or desired for the operation of a 3^{rd} Generation cellular communication system as appropriate.

In particular, the user equipments 101-107, base stations 109, 111, RNC 113 and core network 115 in the system of FIG. 1 comprise the required or desired functionality for operating in accordance with the Technical Specifications of the 3^{rd} Generation Partnership Project (3GPP) for a UMTS cellular communication system as well known to the person skilled in the art.

The UMTS system of FIG. 1 is a CDMA cellular communication system wherein CDMA codes are used to separate different physical communication channels. The CDMA codes are dynamically allocated to the different communication channels by suitable resource allocators. Specifically, each cell has an associated code tree comprising all available codes that may be used in the cell.

In UMTS, the codes used are known as Orthogonal Variable Spreading Factor (OVSF) codes and the code tree comprises all the OVSF codes available to a cell. The codes are selected such that all codes having the same spreading factor are orthogonal. Furthermore, the code tree is arranged such that the branches (children) of a given OVSF code comprises the OVSF codes which have a higher spreading factor but which are not orthogonal to the parent OVSF code. The number of codes at a given hierarchical layer of the code tree corresponds to the spreading factor. Thus, moving up in the code tree results in a lower spreading factor and thus a higher data rate (the chip rate is constant) but with fewer available codes.

The OVSF codes may be allocated for a given service by selecting an available OVSF code having the desired spreading factor from the code tree. However, when a given OVSF code is selected, any codes of the lower hierarchical layers depending from this OVSF code are non-orthogonal and are therefore not usable for other communication channels. Thus, selecting an OVSF code in a code tree not only uses the OVSF code itself but also any OVSF code of a lower layer branch depending therefrom.

In the system of FIG. 1, the RNC 113 comprises a first resource allocator 117 which is operable to allocate codes of the code tree to a first set of calls. The RNC 113 may have a resource allocator for each cell that is managed by it, but for brevity only the resource allocator 117 for the cell of the first base station 101 is illustrated and will be described. Thus, the first resource allocator 117 allocates OVSF codes from a code tree for the cell of base station 101.

The first resource allocator 117 may in the example allocate codes to traditional physical communication channels, such as dedicated channels as defined in Release 99 of the Technical Specifications for UMTS by 3GPP.

In addition, the base station 109 comprises a second resource allocator 119 which is operable to allocate codes of the code tree to a second set of calls. In the specific example, the second resource allocator 119 is a scheduler which allocates code resources to HSDPA communication calls. Thus, the second resource allocator 119 is a fast scheduler located at the base station 109 and capable of allocating OVSF codes to transmissions to different user equipments 101, 103 in response to the current propagation conditions of the radio link to the individual base stations.

In order to ensure that the first resource allocator 117 and the second resource allocator 119 do not allocate the OVSF codes of the code tree used by the other resource allocator, it is necessary to implement a management approach for the sharing of the code tree. Conventionally, this is achieved by a simple static partitioning of the code tree into a set of codes which may be allocated by the first resource allocator 117 and a non-overlapping set of codes which may be allocated by the second resource allocator 119. However, this results in an inflexible and inefficient resource utilisation and may reduce the available capacity and increase call blocking or drop rates.

In the example of FIG. 1, a dynamic resource allocation between codes of the code tree usable by the first resource allocator 117 and the second resource allocator 119 is implemented. Specifically, the base station 101 is arranged to determine the codes used by the first resource allocator 117 in response to call event signalling from the RNC 113. The second resource allocator 119 may then schedule data by using only codes of the code tree which are not blocked by the current code allocation of the first resource allocator 117.

This may allow a very flexible and efficient code resource utilisation, may increase the capacity of the cellular communication system and may reduce call blocking or drop rates. Furthermore, the base station 109 may typically use call event signalling which is already communicated from the RNC 113 to the base station 109 and thus the communication resource usage of the link from the RNC 113 to the base station 109 may not increase.

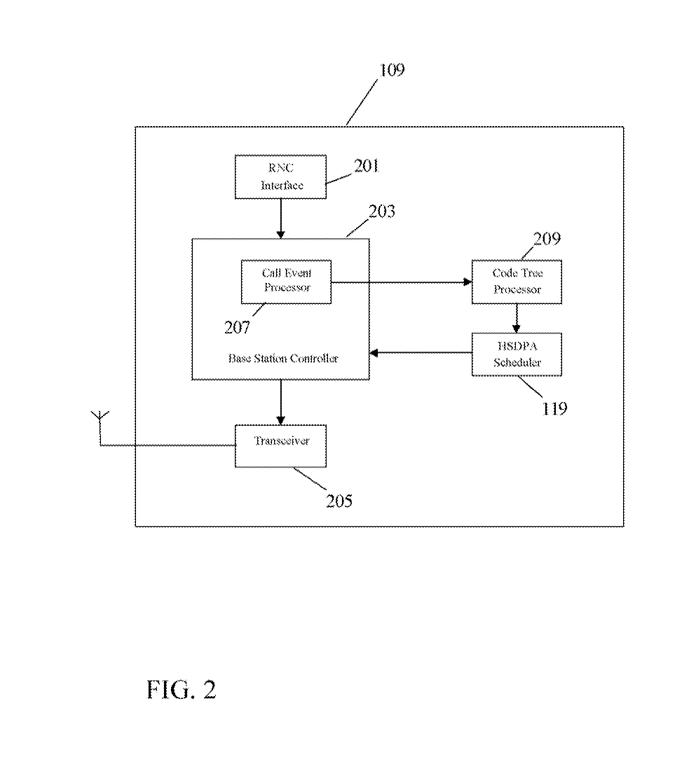

FIG. 2 illustrates elements of a base station incorporating embodiments of the invention. The base station may specifically be the base station 109 of FIG. 1 and will be described with reference to this.

The base station 109 comprises an RNC interface 201 which communicates with the RNC 113 over the communication link between the base station 109 and the RNC 113 (the Iub interface).

The RNC interface 201 is coupled to a base station controller 203 which controls the operation of the base station 109. The base station controller 203 is coupled to a transceiver 205 which is operable to transmit and receive communications to and from user equipment 101, 103 over the air interface in accordance with the Technical Specifications of the UMTS cellular communication system.

The base station controller 203 comprises a call event processor 207 which is operable to detect call event signalling received from the RNC 113. The call event processor 207 is coupled to a code tree processor 209 which is operable to determine OVSF codes that have been allocated by the first resource allocator 117 of the RNC 113 in response to the call event information received from the call event processor 207. In this way, the code tree processor 209 may determine a subset of the code tree which is used by the first resource allocator 117.

Specifically, the call event processor 207 may provide call event information which indicates that a code is used or released. The code tree processor 209 may comprise a table indicating the status of the OVSF codes and when a call event is detected that uses a code, this code (and all dependents of the code) are marked as unavailable. Similarly, when a call event is detected that is associated with a release of a code, this code (and all dependents of the code) are marked as available.

Thus, the code tree processor 209 may designate a code of the code tree as available or unavailable in response to call event signalling for a single call event. As a plurality of call events are detected, the code tree table of the code tree processor 209 accumulates information allowing it to accurately reflect the code tree usage of the first resource allocator 117 of the RNC 113. Furthermore, this dynamic determination of the code usage is very fast as it follows the events giving rise to code allocations and releases very accurately. Furthermore, the call events are signalled from the RNC 113 to the base station 109 in order to execute the call event and thus the code tree availability determination may be achieved without requiring additional signalling between the RNC 113 and the base station 109.

The code tree processor 209 is coupled to the second resource allocator 119 of the base station 109 and is fed information of which codes are available and which codes are not available. The second resource allocator 119 is in the example configured to only allocate codes of the code tree which are designated as available. Thus, the second resource allocator 119 will automatically refrain from allocating codes that have already been allocated by the first resource allocator 117. In this way conflicts may be avoided and an efficient and low complexity sharing of the available code tree is achieved. Furthermore, as the codes of the code tree may be flexibly allocated, a more efficient and flexible resource utilisation is achieved resulting in increased capacity and an increased quality of service.

The second resource allocator 119 is coupled to the base station controller 203 and when a code is required by the base station controller 203, this is requested by the base station controller 203. In response, the second resource allocator 119 selects a suitable code from the available codes and provides it to the base station controller 203. The second resource allocator 119 then indicates that this code (and any descendent of the code in the code tree) is unavailable and the base station controller 203 continues to set up the communication using the allocated code. When the base station controller 203 releases a code, this is furthermore communicated to the second resource allocator 119 which in response indicates that this code (and any descendent of the code in the code tree) is now available.

As a specific example, the UMTS cellular communication system may support HSDPA services and the first resource allocator 117 may be arranged to allocate codes for all non-HSDPA services whereas the second resource allocator 119 allocates codes for all HSDPA services of that cell.

In the example, the call event processor 207 may monitor all ongoing communication with the RNC 113 and may detect any call event belonging to a predetermined group of call events. The predetermined group of call events may be a group of call events which result in an OVSF code being used or released by the first resource allocator 117.

In particular, the call event processor 207 may detect one or more of the following call events:
A call setup. A call setup is typically associated with a code allocation and thus any call setup may indicate that an OVSF code has been used by the first resource allocator 117. When a call is setup, the RNC 113 signals to the base station 109 in order to arrange for the base station 109 to support the call. This signalling includes an indication of the OVSF code to be used by base station 109 and this information may be detected by the call event processor 207 and forwarded to the code tree processor 209.
A handover. A handover is typically associated with a code allocation (handover to the base station 109) or a code release (handover from the base station 109). Thus any handover may indicate that an OVSF code has been used or released by the first resource allocator 117. When a handover is performed, the RNC 113 signals to the base station 109 and this signalling includes an indication of the OVSF code to be used by base station 109 or indicates that a service associated with a previously assigned OVSF code is no longer used. This information may be detected by the call event processor 207 and forwarded to the code tree processor 209.
A call termination. A call termination is typically associated with a code release. Thus any call termination may indicate that an OVSF code has been released by the first resource allocator 117. When a call termination is performed, the RNC 113 signals to the base station 109 and this signalling includes an indication that a service associated with a previously assigned OVSF code is no longer used. This information may be detected by the call event processor 207 and forwarded to the code tree processor 209.
A call reconfiguration. A call reconfiguring may occur where a characteristic of an ongoing call is changed. For example, a data rate of a dedicated channel may be increased or decreased. This may result in a different spreading factor and thus a different code allocation. In particular, a call reconfiguring may result in one code being released by the first resource allocator 117 while another code is occupied by the first resource allocator. When a call reconfiguration occurs, the RNC 113 signals to the base station 109 and this signalling includes an indication that a service associated with a previously assigned OVSF code now uses a different code. This information may be detected by the call event processor 207 and forwarded to the code tree processor 209.

In some embodiments, the first resource allocator 117 and the second resource allocator 119 may be free to select any unused codes of the code tree. However, in other embodiments, the cellular communication system may comprise functionality for designating a first subset of the code tree as allocated to the first resource allocator and a second subset of the code tree as allocated to the second resource allocator.

In some allocations, the first section may only be used by the first resource allocator 117 and the second section may only be used by the second resource allocator 119 whereas codes of a third section may be used by both the first resource allocator 117 and the second resource allocator 119. This may be advantageous in many embodiments as it allows for a flexible resource allocation while ensuring a minimum capacity for each resource allocator.

In some embodiments, the code tree is partitioned into only the first and the second section. Thus, the first resource allocator 117 may only allocate codes from the first section as long as the required codes are available in this section. Similarly, the second resource allocator 119 may only allocate codes from the second section as long as the required codes are available in this section. However, if the required code cannot be allocated from the allocated section, the first resource allocator 117 and/or the second resource allocator 119 may temporarily allocate a code from the other section. Thus, the first resource allocator 117 may “steal” a code from the code partition of the second resource allocator 119 (and/or the second resource allocator 119 may “steal” a code from the code partition of the first resource allocator 117).

In some of the embodiments, the second resource allocator 119 may determine the codes used by the first resource allocator 117 and may determine whether to allocate a code of the first section in response to this determination. For example, if the code tree processor 209 indicates that a number of codes are available in the first section whereas no code is available from the second section of the code tree, the second resource allocator 119 may allocate the code from the first section. The second resource allocator 119 may in this case continue to monitor the call event information in order to detect if the first resource allocator 117 allocates the “stolen” code. If so, the second resource allocator 119 may stop allocating the code. Typically, the code allocation of the second resource allocator 119 is performed faster and in much shorter time intervals (typically 2 ms time intervals) than for the first resource allocator 117 and the second resource allocator 119 may therefore stop allocating the code before it is used by the first resource allocator.

In some embodiments, the base station 109 may occasionally communicate indications of the current code usage level of the second section to the RNC 113. The first resource allocator 117 may use this indication to determine whether to allocate any codes of the second section if no codes are available in the first section. For example, if the usage level indication indicates that almost all of the codes of the second section are in use, it may refrain from temporarily allocating any codes of the second section. However, if the usage level indication indicates that only few codes are used, the performance of the HSDPA system is unlikely to be affected by the first resource allocator 117 allocating codes of the second section, and it may accordingly proceed to do so.

However, in other embodiments, no additional communication is made by the base station 109 and the RNC 113 determines whether to allocate codes of the second section in response to information already available at the RNC 113.

Specifically the first resource allocator 117 may allocate codes of the second subset in response to one or more of the following parameters:
A buffer loading associated with the HSDPA service. The RNC 113 implements RLC (Radio Link Control) queues for the HSDPA services and an increasing length of these queues is indicative of there not being sufficient codes available for the HSDPA channels. Thus, the first resource allocator 117 may choose only to allocate codes of the second section if the buffer loadings are below a given threshold.
A delay associated with the HSDPA service. Delays may be caused by a bottleneck in the transmission path. For example, the base station 109 may queue HSDPA data for transmission if no codes are available for the transmission thereby increasing the delay of the HSDPA service. As another example, the RLC queues of the RNC 113 results in a delay in the HSDPA service and as queue lengths increase, the delay increases. It may thus be more practical in many embodiments to determine a delay associated with the HSDPA service rather than a buffer loading. The first resource allocator 117 may for example choose only to allocate codes of the second section if the delay is below a given threshold. Specifically, the RNC of a 3^{rd} generation system is typically able to estimate delay when the call is carried using RLC (Radio Link Control) acknowledged mode. In acknowledged mode the user equipment provides status reports that indicate which packets have been received correctly and it is possible to configure the user equipment to send these status reports periodically (the period may be quite short eg 100 ms). Using these reports and by noting the time at which the packet was forwarded to the Node B, the RNC can estimate the round trip delay.
A throughput associated with the HSDPA service. A reduced throughput may likewise be caused by a lack of codes available for HSDPA transmissions. The throughput may practically be determined at the RNC 113 in response to the rate of the HSDPA data provided to the base station 109 for transmission, and the first resource allocator 117 may allocate codes of the second section accordingly. For example, the first resource allocator 117 may choose only to allocate codes of the second section if the HSDPA throughput is above a given threshold.
A call admission characteristic associated with the HSDPA service. An increased call blocking for HSDPA services may indicate that there are insufficient codes available to the first resource allocator 117. The first resource allocator 117 may for example refrain from allocating codes of the second section if the admission control is rejecting certain HSDPA call set-up requests. For example, the RNC 113 may track whether streaming bearer call set-ups are being rejected and only allocate codes of the second section if this is not the case.

It will be appreciated that the above description for clarity has described embodiments of the invention with reference to different functional units and processors. However, it will be apparent that any suitable distribution of functionality between different functional units or processors may be used without detracting from the invention. For example, functionality illustrated to be performed by separate processors or controllers may be performed by the same processor or controllers. Hence, references to specific functional units are only to be seen as references to suitable means for providing the described functionality rather than indicative of a strict logical or physical structure or organization.

The invention can be implemented in any suitable form including elements of hardware, software and/or firmware. The invention may optionally be implemented partly as computer software running on one or more data processors and/or digital signal processors. The elements and components of an embodiment of the invention may be physically, functionally and logically implemented in any suitable way. Indeed the functionality may be implemented in a single unit, in a plurality of units or as part of other functional units. As such, the invention may be implemented in a single unit or may be physically and functionally distributed between different units and processors.

Although the present invention has been described in connection with some embodiments, it is not intended to be limited to the specific form set forth herein. Rather, the scope of the present invention is limited only by the accompanying claims. Additionally, although a feature may appear to be described in connection with particular embodiments, one skilled in the art would recognize that various features of the described embodiments may be combined in accordance with the invention. In the claims, the term comprising does not exclude the presence of other elements or steps.

Furthermore, although individually listed, a plurality of means, elements or method steps may be implemented by e.g. a single unit or processor. Additionally, although individual features may be included in different claims, these may possibly be advantageously combined, and the inclusion in different claims does not imply that a combination of features is not feasible and/or advantageous. Also the inclusion of a feature in one category of claims does not imply a limitation to this category but rather indicates that the feature is equally applicable to other claim categories as appropriate. Furthermore, the order of features in the claims do not imply any specific order in which the features must be worked and in particular the order of individual steps in a method claim does not imply that the steps must be performed in this order. Rather, the steps may be performed in any suitable order. In addition, singular references do not exclude a plurality. Thus references to “a”, “an”, “first”, “second” etc do not preclude a plurality.

1. A cellular communication system comprising:
a network controller comprising a first resource allocator for allocating codes to a first set of calls in a cell from a code tree associated with a cell;
a base station coupled to the network controller and comprising a second resource allocator for allocating codes to a second set of calls in the cell from the code tree associated with the cell; wherein
the base station comprises means for determining codes allocated by the first resource allocator in response to call event signalling received from the network controller; and
the second resource allocator is operable to allocate codes in response to the codes allocated by the first resource allocator.

2. A cellular communication system as claimed in claim 1 wherein the means for determining codes allocated by the first resource allocator is operable to determine a subset of the code tree used by the first resource allocator and the second resource allocator is operable to allocate only codes not belonging to the subset.

3. A cellular communication system as claimed in claim 1 wherein the call event signalling comprises signalling for a plurality of call events; and the means for determining codes allocated by the first resource allocator is operable to designate a code of the code tree as unavailable for the second resource allocator in response to call event signalling for a single call event.

4. A cellular communication system as claimed in claim 3 wherein the call event signalling comprises an indication of a code allocation by the first resource allocator associated with the single call event.

5. A cellular communication system as claimed in claim 1 wherein the call event signalling comprises at least one of the group of; call setup signalling, handover signalling, and call termination signalling.

6. A cellular communication system as claimed in claim 1 further comprising means for designating a first subset of the code tree as allocated to the first resource allocator and a second subset of the code tree as allocated to the second resource allocator.

7. A cellular communication system as claimed in claim 1 wherein the first resource allocator is operable to temporarily allocate codes of the second subset to the first set of calls.

8. A cellular communication system as claimed in claim 7 wherein the first resource allocator is operable to allocate codes of the second subset in response to at least one of the group of; a buffer loading associated with the second set of calls, a delay associated with the second set of calls, a throughput associated with the second set of calls, and a call admission characteristic associated with the second set of calls.

9. A cellular communication system as claimed in claim 8 wherein the network controller comprises means for determining an increased code requirement of the second subset by the second resource allocator and the first resource allocator is operable to terminate a call of the first set of calls having a code allocated of the second subset in response to the determination of the increased code requirement.

10. A method of resource allocation in a cellular communication system, the method comprising:
a first resource allocator of a network controller allocating codes to a first set of calls in a cell from a code tree associated with the cell;
at a base station determining codes allocated by the first resource allocator in response to call event signalling received from the network controller; and
a second resource allocator of a base station allocating codes to a second set of calls in the cell from the code tree associated with the cell in response to the codes allocated by the first resource allocator.
